(19) United States
(12) Patent Application Publication
(10) Pub. No.: US 2016/0130532 A1
(43) Pub. Date: May 12, 2016

(54) HYGROSCOPIC DETERGENT FORMULATION COMPRISING WATER, AMINOCARBOXYLATE CHELANT AND MOISTURE-SENSITIVE INGREDIENTS

(71) Applicant: CONOPCO, INC., D/B/A UNILEVER, Englewood Cliffs, NJ (US)

(72) Inventors: Robert Jan MOLL, Dordrecht (NL); Julie Marie Eugenie TAILLARD, Leeds (GB)

(21) Appl. No.: 14/898,561

(22) PCT Filed: Jun. 16, 2014
(86) PCT No.: PCT/EP2014/062502

§ 371 Date: Dec. 15, 2015

(30) Foreign Application Priority Data
Jun. 25, 2013 (EP) 13173496.4

(51) Int. Cl. C11D 3/33; C11D 11/00; C11D 17/04; C11D 3/20

(52) U.S. Cl. CPC C11D 3/33; C11D 3/2065; C11D 11/0094; C11D 17/043

(57) ABSTRACT

The present invention relates to a detergent formulation comprising water, one or more moisture-sensitive detergent ingredients and an aminocarboxylate chelant comprising at least three carboxylate residues; wherein the combination of aminocarboxylate chelant and water represents at least 20% by weight of the detergent formulation; wherein the weight ratio of aminocarboxylate chelant to water lies within the range of 5:6 to 5:1; and wherein the detergent formulation has a pH in the range of 7.2 to 12. The detergent composition offers the advantage that adverse effects of water uptake during storage are minimized. The invention further relates to detergent product comprising a container that holds the aforementioned detergent formulation.

### TECHNICAL FIELD OF THE INVENTION

The present invention relates to a hygroscopic detergent formulation comprising an aminocarboxylate chelant with at least three carboxylate residues, water, and one or more moisture-sensitive detergent ingredients. More particularly, the present invention relates to such a composition wherein the combination of aminocarboxylate chelant and water represents at least 20% by weight of the detergent formulation; wherein the weight ratio of aminocarboxylate chelant to water lies within the range of 5:6 to 5:1; and wherein the detergent formulation has a pH in the range of 7.2 to 12.

The aminocarboxylate chelant in the detergent composition is at least partially protonated. Partial protonation of the aminocarboxylate chelant can be achieved, for instance, by employing a completely deprotonated salt of the aminocarboxylate chelant in combination with a substantial amount of an acid, such as citric acid. Examples of suitable aminocarboxylate chelants include alkali metal salts of methylglycinediacetic acid (MGDA), nitrilotriacetic acid (NTA), glutamic acid N,N-diacetic acid (GLDA) and hydroxyethylethylenediaminetriacetic acid (HEEDTA).

The hygroscopic detergent formulation of the present invention offers the advantage that adverse effects of water uptake on the moisture-sensitive detergent ingredients are minimized.

Examples of detergent compositions according to the present invention include dishwashing compositions, notably encapsulated machine dishwashing compositions.

### BACKGROUND OF THE INVENTION

Detergent formulations typically contain a number of different active components, including builders, surfactants, enzymes and bleaching agents.

Surfactants are employed to release stains and soil and to disperse the released components into the cleaning liquid. Enzymes help to remove stubborn stains of proteins, starch and lipids by hydrolyzing these components. Bleaching agents are employed in detergent compositions to remove bleachable stains, such as those associated with tea, coffee, red wine, and various fruit and vegetable products, by oxidizing the components that make up these stains. Typical bleaching agents for use in detergent formulations are chlorine- and peroxygen-based compounds, such as hypochlorite and percarbonate bleach, respectively.

Builders are incorporated in detergent formulations to complex magnesium and calcium ions as well as to maintain alkaline pH conditions. Phosphorous based builders, such as phosphates, have been used for many years in a wide variety of detergent compositions. However, as part of an increasing trend towards environmentally friendly detergent compositions, alternative building agents have been developed and these alternative builders have found their way into commercial detergent products. The aminocarboxylate chelant L-glutamic-N,N-diacetate is an example of an environmentally friendly builder that is used in commercial detergent products. Generally, aminocarboxylate chelants are present in detergent formulations in the form of their (fully deprotonated) sodium salts. Aqueous solutions of aminocarboxylate salts are alkaline, with a 1% (w/w) solution in distilled water typically having a pH in the range of 11-12.

Aminocarboxylate salts such as tetrasodium L-glutamic-N,N-diacetate (Na₄-GLDA, or “GLDA”) are known to be highly hygroscopic. This may pose a problem in detergent formulations that contain a large amount of aminocarboxylate chelant relative to water, as water uptake by the detergent formulation from its surroundings may cause instability of the detergent formulation.

Bleaching agents and enzymes are examples of moisture-sensitive detergent ingredients. Water uptake by a detergent composition may cause these moisture-sensitive detergent ingredients to lose their activity over time. For commonly employed chlorine- and peroxygen-based bleaching agents, moisture induced degradation is typically accompanied by the formation of gaseous decomposition products. If the detergent composition is stored in a container, such as a sachet or a capsule, pressure build-up may occur, leading to undesirable expansion or even tearing or bursting.

WO 2007/025666 describes liquid detergent compositions with improved cleaning action, comprising dual-compartment pouches containing two separate liquid compositions having differing pH values of 6-9 (A) and either 4-7 (B) or 9.5-14 (B). Composition (B) contains bleaching agent. MGDA is especially preferred as builder, in a concentration of 0.2-12% by total weight of (A) and (B).

WO 2007/141527 describes a liquid detergent composition comprising a non-phosphorous amino acid based or succinate based builder, one or more enzymes that are destabilized by this builder, and a stabilization system for the enzymes that comprises one or more divalent metal compounds or salts and one or more non-ionic surfactants. The example describes a water-soluble polyvinyl alcohol pouch filled with a composition comprising 58.7 wt % water, 31.0 wt % glutamic acid N,N-diacetate (GLDA) and 5.5 wt % citric acid. The pH of this system is listed as 8.1 at 100 wt % (undiluted), 8.8 at 10 wt % and 9.3 at 1 wt %.

DE 10 2011 000889 describes an automatic dishwashing detergent composition comprising enzyme, Borax, phosphoric acid esters, complexing agents, a solubilizer, nonionic surfactants, propylene glycol and water. MGDA and GLDA are mentioned as examples of complexing agents. Example 1 describes a detergent composition containing 14.997 wt. % MGDA and 31.549 wt. % water. Example 2 describes a detergent composition containing 14.980 wt. % GLDA and 31.625 wt. % water.

Non-prior published patent application WO 2013/092276 describes a detergent formulation containing 39.8 wt. % GLDA, 30.8 wt. % water, 1.49 wt. % citric acid, coated spray-dried percarbonate, enzymes and other ingredients. The PCT application further describes a detergent formulation containing 40.9 wt. % GLDA, 26.9 wt. % water, 1.93 wt. % citric acid, coated spray-dried percarbonate and other ingredients. The PCT application also describes a formulation containing 38.6 wt. % MGDA, 34.9 wt. % water and 1.49 wt. % citric acid.

Non-prior published patent application EP13171584.9 describes detergent formulations containing 51.9-55.6 parts by weight GLDA, 42.5-43.0 parts by weight water, 1.37-1.38 parts by weight citric acid, coated sodium percarbonate and enzyme granulate.

It is an object of the present invention to provide a hygroscopic detergent formulations comprising aminocarboxylate, water and moisture sensitive ingredients and that exhibit reduced sensitivity to moisture uptake.

### SUMMARY OF THE INVENTION

The present inventors have unexpectedly discovered that the aforementioned objective can be realized by providing a detergent formulation wherein the aminocarboxylate chelant is at least partially protonated, as evidenced by a moderately basic pH.

Although the inventors do not wish to be bound by theory, it is believed that the presence of the aminocarboxylate chelant in partially protonated form reduces the inherent hygroscopicity of the detergent formulation. At the same time, the pH decrease associated with the partial protonation of the aminocarboxylate chelant can in itself affect the stability of moisture-sensitive ingredients, such as bleaching agent. It was surprisingly found by the inventors that although this pH decrease may cause a decrease in bleaching activity, at the same time the unwanted formation of gaseous decomposition products was significantly reduced.

Thus, the present invention enables the preparation of hygroscopic detergent formulations containing one or more moisture-sensitive ingredients that exhibit improved stability against water uptake during storage.

Accordingly, the detergent formulation of the present invention can suitably be packaged in a water-permeable container, such as a PVA sachet, or in containers that are repeatedly opened by the consumer during use.

### DEFINITIONS

The term “aminocarboxylate chelant” as used herein refers to compounds containing one or more nitrogen atoms connected through carbon atoms to one or more carboxylate groups, which form strong complexes with metal ions by donation of electron pairs from the nitrogen and oxygen atoms to the metal ion to form multiple chelate rings.

The term “moisture-sensitive detergent ingredient” as used herein refers to a compound that is suitable for use in detergent formulation, which may partially or fully decompose due to interaction with water molecules and/or lose its activity due to interaction with water.

The term “water permeable” in relation to the packaging material as described herein means that water is able to migrate through said packaging material.

The term “water solubility” in relation to the aminocarboxylate chelant as described herein relates to a solubility as measured in distilled water at 20° C. at atmospheric pressure.

The term “conjugate base” as used herein refers to the species that is formed when an acid donates one or more of its available protons. Thus, for an acid HA, A- is its conjugate base. Similarly, for polyprotic acids H₂A and H₃A etc., the conjugate bases are [HA⁻, A²⁻] and [H₂A⁻, HA²⁻, A³⁻], respectively.

Whenever reference is made herein to water content, unless indicated otherwise, said water content includes unbound (free) as well as bound water.

Whenever a parameter, such as a concentration or a ratio, is said to be less than a certain upper limit it should be understood that in the absence of a specified lower limit the lower limit for said parameter is 0.

Whenever an amount or concentration of a component is quantified herein, unless indicated otherwise, the quantified amount or quantified concentration relates to said component per se, even though it may be common practice to add such a component in the form of a solution or of a blend with one or more other ingredients.

The term “comprising” is used herein in its ordinary meaning and means including, made up of, composed of, consisting and/or consisting essentially of. In other words, the term is defined as not being exhaustive of the steps, components, ingredients, or features to which it refers.

### DETAILED DESCRIPTION OF THE INVENTION

Accordingly, one aspect of the present invention relates to a detergent formulation comprising water, one or more moisture-sensitive detergent ingredients and an aminocarboxylate chelant comprising at least three carboxylate residues; wherein the combination of aminocarboxylate chelant and water represents at least 20% by weight of the detergent formulation; wherein the weight ratio of aminocarboxylate chelant to water lies within the range of 5:6 to 5:1; and wherein the detergent formulation has a pH in the range of 7.2 to 12.

The pH of the detergent formulation is suitably measured by employing a Schott pH Meter Lab 860 equipped with a Blueline Calomel-glass combination electrode, using a stirring time of 15 minutes. Unless indicated otherwise, the pH of the detergent formulation is the pH determined in the undiluted formulation.

Unlike the GLDA and citric acid containing formulations described in non-prior published patent applications WO 2013/092276 and EP13171584.9, the present detergent formulation preferably contains citric acid (including citrate) and GLDA in a molar ratio of more than 1:12, more preferably of more than 1:10, even more preferably of more than 1:8, most preferably of more than 1:6.

Unlike the MGDA and citric acid containing formulations described in non-prior published patent application WO 2013/092276, the present detergent formulation preferably contains citric acid (including citrate) and MGDA in a molar ratio of more than 1:18, more preferably of more than 1:15.

As explained herein before, the present invention enables the preparation of a hygroscopic detergent formulation that mainly consists of aminocarboxylate, water and moisture sensitive ingredients, and that exhibits reduced sensitivity to moisture uptake. The hygroscopicity of the detergent formulation is apparent from the fact that the formulation attracts and holds water molecules from the surrounding environment.

The hygroscopicity of the detergent formulation can suitably be determined by measuring the increase over time of the weight of a sample of the detergent formulation under controlled temperature and relative humidity conditions. Typically, when a plastic (PE) petri dish (inner diameter=105 mm) containing 25 grams of detergent formulation is kept at a temperature of 20° C. and a relative humidity (RH) of 64% for 7 days, the detergent formulation shows a weight increase of at least 1%, more preferably of at least 4%, most preferably at least 10% by weight of the detergent formulation. Preferably, the detergent formulation shows a weight increase under these conditions of at most 50%, more preferably at most 40%, most preferably at most 35% by weight of the detergent formulation.

The detergent formulation of the present invention can be a liquid, a solid (e.g. a powder, a granulate or a tablet) or a paste. Preferably, the detergent formulation is a liquid or a paste.

The detergent formulation of the invention contains an aminocarboxylate chelant comprising at least three carboxylate residues. Preferably, the aminocarboxylate chelant comprises 3 to 6 carboxylate residues.

Aminocarboxylate chelants having three carboxylate residues are preferably selected from methylglycinediacetic acid (MGDA), nitrilotriacetic acid (NTA), glutamic acid N,N-diacetic acid (GLDA), hydroxyethylethylenediaminetriacetic acid (HEEDTA), their salts, and combinations thereof.

Aminocarboxylate chelants having four carboxylate residues are preferably selected from ethylenediaminedifumaric acid (EDDF), ethylenediaminedimalic acid (EDDM), ethylenediamineditartaric acid (EDDT), ethylenediaminedisuccinic acid (EDDS), aspartic acid-N,N-diacetic acid (ASDA), hydroxyethylenediaminetetraacetic acid (HEDTA), iminodisuccinic acid (IDS), ethylenediaminetetraacetic acid (EDTA), iminodifumaric acid (IDF), iminoditartaric acid (IDT), iminodimaleic acid (IDMAL), iminodimalic acid (IDM), ethylenediaminedimaleic acid (EDDMAL), their salts, and combinations thereof.

Aminocarboxylate chelants having five or more carboxylate residues are preferably selected from diethylenetriaminepentaacetic acid (DTPA), aspartic acid diethoxysuccinic acid (AES), their salts, and combinations thereof.

According to a preferred embodiment, the aminocarboxylate chelant is selected from GLDA, MGDA, IDS and combinations thereof. The inventors have found that GLDA is particularly useful as this chelant can be used to prepare detergent formulations, notably liquid detergent formulations, with a high water content that are highly stable despite the presence of moisture-sensitive ingredients. Consequently, in according with a particularly preferred embodiment the aminocarboxylate chelant is GLDA.

The benefits of the present invention are particularly apparent if the weight ratio of aminocarboxylate chelant to water in the detergent formulation lies within the range of 9:10 to 3:1; more preferably of 1:1 to 5:2; and most preferably of 5:4 to 2:1.

The present detergent formulation preferably contains 25-80%, more preferably 30-75% of the aminocarboxylate chelant by weight of the formulation. Even more preferably, the formulation contains 32-70% and most preferably 33-60% of the aminocarboxylate chelant by weight of the formulation.

Together, the aminocarboxylate chelant and water typically represent at least 35 wt. %, more preferably at least 45 wt. % and most preferably at least 50 wt. % of the present formulation.

The water content of the present composition preferably lies in the range of 10-55 wt. %, more preferably of 15-50 wt. % and most preferably of 20-48 wt. %.

The present formulation may suitably contain a substantial amount of non-dissolved detergent components, such as bleaching agent, enzyme preparations and surfactants. Typically, the amount of non-dissolved detergent components does not exceed 70 wt. %. More preferably, non-dissolved detergent components represent not more than 60 wt. %, even more preferably not more than 55 wt. % and most preferably not more than 50 wt. % of the formulation.

Together the aminocarboxylate chelant, water and non-dissolved detergent components typically constitute at least 60 wt. %, more preferably at least 70 wt. % and most preferably at least 80 wt. % of the detergent formulation.

The benefits of the present invention are most evident if the water solubility of the aminocarboxylate chelant is relatively high. Typically, the aminocarboxylate chelant has a solubility in distilled water at 20° C. and atmospheric pressure of at least 30 wt. %, preferably 50 wt. %, more preferably at least 60 wt. %.

As explained herein before, the present invention is based on the surprising finding that partial protonation of the carboxylate groups of the aminocarboxylate chelants results in a detergent formulation that is less sensitive/susceptible to water uptake from its surroundings. Protonation is typically achieved by incorporating a suitable amount of one or more acids to the detergent formulation. As a consequence of the partial protonation of the aminocarboxylate chelant, the pH of the detergent composition of the invention is less alkaline than that of detergent systems comprising a large amount of conventional (fully deprotonated) aminocarboxylate chelant salts.

It is preferred that the detergent formulation according to the invention has a pH in the range of 7.5 to 11.5, more preferably in the range of 7.8 to 11.0, even more preferably in the range of 8.0 to 10.5, most preferably in the range of 8.2 to 10.

Suitable acids for use in the detergent formulation according to the invention are organic acids such as hydroxyacetic (glycolic) acid, citric acid, formic acid, acetic acid, propionic acid, butyric acid, valeric acid, caproic acid, gluconic acid, itaconic acid, trichloroacetic acid, urea hydrochloride, benzoic acid, oxalic acid, malic acid, malonic acid, succinic acid, glutaric acid, maleic acid, fumaric acid, adipic acid, and terephthalic acid, and combinations thereof. Suitable inorganic acids include sulphuric acid, sulfamic acid, methylsulfamic acid, hydrochloric acid, hydrobromic acid, hydrofluoric acid, and nitric acid, and combinations thereof.

Preferably, the acid has a dissociation constant for the first proton Kₐ₁ of at least 1×10⁻⁶, more preferably at least 1×10⁻⁵, most preferably at least 1×10⁻⁴

In a preferred embodiment, the detergent formulation comprises citric acid. In another preferred embodiment, the detergent formulation comprises sulphuric acid.

It is preferred that the one or more acids are added in such an amount that the detergent formulation contains at least 5 millimoles (mmoles) of the conjugate bases of these acids per 100 g of detergent formulation. In a more preferred embodiment, the detergent formulation contains at least 10 mmoles, even more preferably at least 12 mmoles, even more preferably at least 15 mmoles, yet even more preferably at least at least 18 mmoles, most preferably at least 20 mmoles per 100 g detergent formulation of these conjugate bases. It is further preferred that the detergent formulation contains at most 100, more preferably at most 80, even more preferably at most 75, yet even more preferably at most 72, most preferably at most 70 mmoles per 100 g of detergent formulation of the aforementioned conjugate bases.

The detergent formulation typically contains conjugate bases of the aforementioned acids and the aminocarboxylate chelant in a molar ratio that lies in the range of 1:50 to 1:1, more preferably in the range of 1:25 to 2:3, even more preferably in the range of 1:15 to 1:2 and most preferably in the range of 1:12 to 1:3.

The water activity (A_{w}) of the detergent formulation typically does not exceed 0.85. Preferably, it does not exceed 0.75, most preferably it does not exceed 0.6. The water activity of the formulation is preferably larger than 0.2, more preferably larger than 0.3. The water activity of the formulation may suitably be determined by a Novasina Labmaster conditioned A_{w} measuring device that is set at 25° C. and measured until stable.

### Moisture-Sensitive Ingredients

As explained herein before, the detergent compositions of the present invention offer the important advantage that moisture-sensitive detergent ingredients can be incorporated in the detergent formulation without said moisture-sensitive ingredients suffering unacceptable activity loss or degradation.

Examples of detergent ingredients that can be moisture sensitive include bleaching agents, bleach activators, bleach catalysts, perfumes, colorants, and enzymes.

In a preferred embodiment, the detergent formulation of the invention contains a moisture sensitive bleaching agent.

In a preferred embodiment, the detergent formulation contains a moisture sensitive enzyme.

In a particularly preferred embodiment, the detergent formulation of the invention contains both moisture sensitive bleaching agent and moisture sensitive enzyme.

### Bleaching Agent

In a preferred embodiment, the detergent formulation contains at least 0.3 wt. %, preferably at least 2 wt. % and most preferably at least 6 wt. % of bleaching agent by total weight of the formulation.

The bleaching agent of the present formulation preferably comprise a chlorine-, or bromine-releasing agent or a peroxygen compound. Preferably, the bleaching agent is selected from peroxides (including peroxide salts such as sodium percarbonate), organic peracids, salts of organic peracids and combinations thereof. More preferably, the bleaching agent is a peroxide. Most preferably, the bleaching agent is a percarbonate.

Examples of peroxides are acids and corresponding salts of monopersulphate, perborate monohydrate, perborate tetrahydrate, and percarbonate.

Organic peracids useful herein include alkyl peroxy acids and aryl peroxyacids such as peroxybenzoic acid and ring-substituted peroxybenzoic acids (e.g. peroxy-alpha-naphthoic acid), aliphatic and substituted aliphatic monoperoxy acids (e.g. peroxylauric acid and peroxystearic acid), and phthaloyl amido peroxy caproic acid (PAP).

Typical diperoxy acids useful herein include alkyl diperoxy acids and aryldiperoxy acids, such as 1,12-di-peroxy-dodecanedioic acid (DPDA), 1,9-diperoxyazelaic acid, diperoxybrassylic acid, diperoxysebacic acid and diperoxy-isophthalic acid, and 2-decyldiperoxybutane-1,4-dioic acid.

In a preferred embodiment, the bleaching agent is present as dispersed particles.

According to a preferred embodiment, the present formulation comprises coated bleach particles. According to a particularly preferred embodiment, the coated bleach particles comprise a water-soluble coating. The water-soluble coating advantageously comprises a coating agent selected from alkali sulphate, alkali carbonate or alkali chloride and combinations thereof.

The coating of the bleaching agent can be done by, for example, crystallisation or by spray granulation. Suitable coated bleaching agents are described in, for example, EP-A 0 891 417, EP-A 0 136 580 and EP-A 0 863 842. The use of spray granulated coated percarbonate is most preferred.

The detergent formulation may contain one or more bleach activators such as peroxyacid bleach precursors. Peroxyacid bleach precursors are well known in the art. As non-limiting examples can be named N,N,N′,N′-tetraacetyl ethylene diamine (TAED), sodium nonanoyloxybenzene sulphonate (SNOBS), sodium benzoyloxybenzene sulphonate (SBOBS) and the cationic peroxyacid precursor (SPCC) as described in U.S. Pat. No. 4,751,015.

If desirable, a bleach catalyst, such as the manganese complex, e.g. Mn-Me TACN, as described in EP-A-0458397, or the sulphonimines of U.S. Pat. No. 5,041,232 and U.S. Pat. No. 5,047,163, can be incorporated. This bleach catalyst may suitably be present in the formulation in the form of a encapsulate, notably an encapsulate that is separate from the bleach particles (to avoid premature bleach activation). Cobalt or iron catalysts can also be used.

### Enzymes

The high moisture-stability of the formulation of the invention makes it possible to incorporate enzymes in the formulation without the formulation suffering from segregation or degradation of the enzymes. Hence, in a preferred embodiment of the invention, the formulation comprises one or more enzymes, preferably in the form of a powder, granulate or encapsulate.

Examples of enzymes suitable for use in the formulations of this invention include lipases, cellulases, peroxidases, proteases (proteolytic enzymes), amylases (amylolytic enzymes) and others which degrade, alter or facilitate the degradation or alteration of biochemical soils and stains encountered in cleansing situations so as to remove more easily the soil or stain from the object being washed to make the soil or stain more removable in a subsequent cleansing step. Both degradation and alteration can improve soil removal.

Well-known and preferred examples of these enzymes are proteases, amylases, cellulases, peroxidases, mannanases, pectate lyases and lipases and combinations thereof. The enzymes most commonly used in detergent formulations are proteolytic and amylolytic enzymes.

The formulation of the present invention typically contains at least 10 mg/kg, more preferably at least 20 mg/kg, even more preferably at least 50 mg/kg and most preferably at least 100 mg/kg of enzyme. The concentration of enzyme preferably does not exceed 50 g/kg, more preferably it does not exceed 40 g/kg and most preferably it does not exceed 30 g/kg.

In a preferred embodiment of this invention the enzymes are present in encapsulated form. Well known enzyme stabilizers such as polyalcohols/borax, calcium, formate or protease inhibitors like 4-formylphenyl boronic acid may also be present in the formulation The proteolytic enzymes in this invention include metalloproteases and serine proteases, including neutral or alkaline microbial serine protease, such as subtilisins (EC 3.4.21.62). The proteolytic enzymes for use in the present invention can be those derived from bacteria of fungi. Chemically or genetically modified mutants (variants) are included. Preferred proteolytic enzymes are those derived from Bacillus, such as B. lentus, B. gibsonii, B. subtilis, B. licheniformis, B. alkalophilus, B. amyloliquefaciens and Bacillus pumilus, of which B. lentus and B. gibsonii are most preferred. Examples of such proteolytic enzymes are Excellase™, Properase™, Purafect™, Purafect™ Prime, Purafect™ Ox by Genencor; and those sold under the trade names Blaze™, Ovozyme™, Savinase™, Alcalase™, Everlase™, Esperase™ Relase™, Polarzyme™, Liquinase™ and Coronase™ by Novozymes.

According to a preferred embodiment, the composition contains at least 100 mg/kg, more preferably at least 200 mg/kg and most preferably at least 400 mg/kg of protease.

The amylolytic enzymes for use in the present invention can be those derived from bacteria or fungi. Chemically or genetically modified mutants (variants) are included. Preferred amylolytic enzyme is an alpha-amylase derived from a strain of Bacillus, such as B. subtilis, B. licheniformis, B. amyloliquefaciens or B. stearothermophilus. Examples of such amylolytic enzymes are produced and distributed under the trade name of Stainzyme™, Stainzyme™ Plus, Termamyl™, Natalase™ and Duramyl™ by Novozymes; as well as Powerase™, Purastar™, Purastar™ Oxam by Genencor. Stainzyme™, Stainzyme™ Plus and Powerase™ are the preferred amylases.

According to another preferred embodiment, the composition contains at least 10 mg/kg, more preferably at least 20 mg/kg and most preferably at least 50 mg/kg of amylase.

The enzymes may suitably be incorporated in the detergent formulation in or in encapsulated form. In case the formulation has a pH of 9.0 and more it is preferred to employ enzymes in encapsulated form.

Examples of encapsulated forms are enzyme granule types D, E and HS by Genencor and granule types, T, GT, GTT, TXT and Evity™ of Novozymes.

In case the pH is less than 9.0 it can be advantageous to employ non-encapsulated enzymes.

### Silica

The detergent formulation may suitably contain 0.5-5.0 wt. % silica. The silica material may be selected from amorphous silica, precipitated, fumed silica, gel-formation formed silica and mixtures thereof.

Preferably, the water-soluble surfactant and the silica together constitute at least 2 wt. %, more preferably at least 3 wt. % of the detergent formulation.

### Silicates

Silicates may be added to the formulation. Silicates can act as builder, buffering agent or article care agent. Preferred silicates are sodium silicate such as sodium disillicate, sodium metasilicate and crystalline phyllosilicates and mixtures thereof. Silicates are preferably used in the detergent composition in a concentration of 1 to 20%, more preferably of 2 to 10% by weight of the composition.

### Surfactants

The present detergent formulation preferably contains one or more surfactants. Surfactants, within the invention, are components within the classification as described in “Surfactant Science Series”, Vol. 82, Handbook of detergents, part A: Properties, chapter 2 (Surfactants, classification), G. Broze (ed.).

According to a particularly preferred embodiment, the formulation contains 0.1-15 wt. %, more preferably 0.5-10 wt. % and most preferably 1-5 wt. % of a nonionic surfactant or a mixture of two or more non-ionic surfactants.

Examples of nonionic surfactants that may be employed in the present formulation include the condensation products of hydrophobic alkyl, alkenyl, or alkyl aromatic compounds bearing functional groups having free reactive hydrogen available for condensation with hydrophilic alkylene oxide, such as ethylene oxide, propylene oxide, butylene oxide, polyethylene oxide or polyethylene glycol to form nonionic surfactants. Examples of such functional groups include hydroxy, carboxy, mercapto, amino or amido groups.

Examples of useful hydrophobes of commercial nonionic surfactants include C8-C18 alkyl fatty alcohols, C₈-C₁₄ alkyl phenols, C₈-C₁₈ alkyl fatty acids, C₈-C₁₈ alkyl mercaptans, C₈-C₁₈ alkyl fatty amines, C₈-C₁₈ alkyl amides and C₈-C₁₈ alkyl fatty alkanolamides. Accordingly, suitable ethoxylated fatty alcohols may be chosen from ethoxylated cetyl alcohol, ethoxylated ketostearyl alcohol, ethoxylated isotridecyl alcohol, ethoxylated lauric alcohol, ethoxylated oleyl alcohol and mixtures thereof.

Examples of suitable nonionic surfactants for use in the invention are found in the low- to non-foaming ethoxylated/propoxylated straight-chain alcohols of the Plurafac™ LF series, supplied by the BASF and the Synperonic™ NCA series supplied by Croda. Also of interest are the end-capped ethoxylated alcohols available as the SLF 18 series from BASF and the alkylpolyethylene glycol ethers made from a linear, saturated C₁₆-C₁₈ fatty alcohol of the Lutensol™ AT series, supplied by BASF. Other suitable nonionics to apply in the formulation of the invention are modified fatty alcohol polyglycolethers available as Dehypon™ 3697 GRA or Dehypon™ Wet from BASF/Cognis. Also suitable for use herein are nonionics from the Lutensol™ TO series of BASF, which are alkylpolyethylene glycol ethers made from a saturated iso-C₁₃ alcohol.

Amineoxide surfactants may also be used in the present invention as anti-redeposition surfactant. Examples of suitable amineoxide surfactants are C₁₀-C₁₈ alkyl dimethylamine oxide and C₁₀-C₁₈ acylamido alkyl dimethylamine oxide.

The inventors have found that a detergent formulation that is not only chemically but also physically very stable can be produced if the nonionic surfactant employed is solid at ambient temperature. Thus, advantageously, the present formulation contains 0.1-15 wt. %, more preferably 0.5-10 wt. % and most preferably 1-5 wt. % of nonionic surfactant that is solid at 25° C.

If an anionic surfactant is used, the total amount present preferably is less than 5 wt. %, and more preferably not more than 2 wt. %. Furthermore, if an anionic surfactant is present, it is preferred that an antifoam agent to suppress foaming is present. Examples of suitable anionic surfactants are methylester sulphonates or sodium lauryl sulphate.

### Other Ingredients

In a preferred embodiment of the current invention, the detergent formulation furthermore comprises at least one dispersing polymer. Dispersing polymers as referred to in this invention are chosen from the group of anti-spotting agents and/or anti-scaling agents.

Examples of suitable anti-spotting polymeric agents include hydrophobically modified polycarboxylic acids such as Acusol™ 460 ND (ex Dow) and Alcosperse™ 747 by AkzoNobel, whereas also synthetic clays, and preferably those synthetic clays which have a high surface area are very useful to prevent spots, in particular those formed where soil and dispersed remnants are present at places where the water collects on the glass and spots formed when the water subsequently evaporates.

Examples of suitable anti-scaling agents include organic phosphonates, amino carboxylates, polyfunctionally-substituted compounds, and mixtures thereof. Particularly preferred anti-scaling agents are organic phosphonates such as [symbol] -hydroxy-2 phenyl ethyl diphosphonate, ethylene diphosphonate, hydroxy 1,1-hexylidene, vinylidene 1,1-diphosphonate, 1,2-dihydroxyethane 1,1-diphosphonate and hydroxy-ethylene 1,1-diphosphonate. Most preferred is hydroxy-ethylene 1,1-diphosphonate (EDHP) and 2-phosphono-butane, 1,2,4-tricarboxylic acid (Bayhibit ex Bayer).

Suitable anti-scaling agents are water soluble dispersing polymers prepared from an allyloxybenzenesulfonic acid monomer, a methallyl sulfonic acid monomer, a copolymerizable nonionic monomer and a copolymerizable olefinically unsaturated carboxylic acid monomer as described in U.S. Pat. No. 5,547,612 or known as acrylic sulphonated polymers as described in EP 851 022. Polymers of this type include polyacrylate with methyl methacrylate, sodium methallyl sulphonate and sulphophenol methallyl ether such as Alcosperse™ 240 supplied (AkzoNobel). Also suitable is a terpolymer containing polyacrylate with 2-acrylamido-2 methylpropane sulphonic acid such as Acumer 3100 supplied by Dow. As an alternative, polymers and co-polymers of acrylic acid having a molecular weight between 500 and 20,000 can also be used, such as homo-polymeric polycarboxylic acid compounds with acrylic acid as the monomeric unit. The average weight of such homo-polymers in the acid form preferably ranges from 1,000 to 100,000 particularly from 3,000 to 10,000 e.g. Sokolan™ PA 25 from BASF or Acusol™ 425 from Dow.

Also suitable are polycarboxylates co-polymers derived from monomers of acrylic acid and maleic acid, such as CP 5 from BASF. The average molecular weight of these polymers in the acid form preferably ranges from 4,000 to 70,000. Modified polycarboxylates like Sokalan™CP42, Sokalan™ CP50 from BASF or Alcoguard™ 4160 from AkzoNobel may also be used.

Mixture of anti-scaling agents may also be used. Particularly useful is a mixture of organic phosphonates and polymers of acrylic acid.

It is preferable if the level of dispersing polymers ranges from 0.2 to 10 wt. % of the total formulation, preferably from 0.5 to 8 wt. %, and further preferred from 1 to 6 wt. %.

Glass corrosion inhibitors can prevent the irreversible corrosion and iridescence of glass surfaces in machine dishwash detergents. The claimed formulation may suitably contain glass corrosion inhibitors. Suitable glass corrosion agents can be selected from the group the group consisting of salts of zinc, bismuth, aluminum, tin, magnesium, calcium, strontium, titanium, zirconium, manganese, lanthanum, mixtures thereof and precursors thereof. Most preferred are salts of bismuth, magnesium or zinc or combinations thereof. Preferred levels of glass corrosion inhibitors in the present composition are 0.01-2 wt. %, more preferably 0.01-0.5 wt. %.

Anti-tarnishing agents may prevent or reduce the tarnishing, corrosion or oxidation of metals such as silver, copper, aluminium and stainless steel. Anti-tarnishing agents such as benzotriazole or bis-benzotriazole and substituted or substituted derivatives thereof and those described in EP 723 577 (Unilever) may also be included in the formulation. Other anti-tarnishing agents that may be included in the detergent formulation are mentioned in WO 94/26860 and WO 94/26859. Suitable redox active agents are for example complexes chosen from the group of cerium, cobalt, hafnium, gallium, manganese, titanium, vanadium, zinc or zirconium, in which the metal are in the oxidation state of II, II, IV V or VI.

The present formulation may suitably contain a non-surfactant, water-soluble, liquid binder, e.g. in a concentration of 0-50% by weight of the continuous phase. Examples of such liquid binders include polyethylene glycols, polypropylene glycols, glycerol, glycerol carbonate, ethylene glycol, propylene gylcol and propylene carbonate.

Optionally other components may be added to the formulation such as perfume, colorant or preservatives.

The invention further relates to a detergent product comprising:
a. a container; and
b. a detergent formulation that is contained in said container, wherein the detergent formulation is a detergent formulation as defined herein.

The container may be any container that is suitable for holding a detergent formulation. In accordance with one embodiment, the container holds one unit of the detergent formulation and is at least partly made from water-soluble material. Detergent products comprising such a container can, for instance, be introduced in a dishwashing machine or laundry washing machine and will release the detergent formulation when water is introduced into the machine during the washing operation. Examples of containers that may be used in accordance with this embodiment are sachets (pouches) and capsules.

The benefits of the present invention are particularly pronounced in case the container is not only water-insoluble, but also water-permeable. More particularly, it is preferred that the container is made of a water-permeable and water-soluble polymer selected from polyvinyl alcohol, cellulose ethers, polyethylene oxide, starch, polyvinylpyrrolidone, polyacrylamide, polyvinyl methyl ether-maleic anhydride, polymaleic anhydride, styrene maleic anhydride, hydroxyethylcellulose, methylcellulose, polyethylene glycols, carboxymethylcellulose, polyacrylic acid salts, alginates, acrylamide copolymers, guar gum, casein, ethylene-maleic anhydride resin series, polyethylene imine, ethyl hydroxyethylcellulose, ethyl methylcellulose, hydroxyethyl methylcellulose and combinations thereof. Even more preferably, the container is made of polyvinyl alcohol, polyethelene oxide, polyvinylpyrrolidone and combinations thereof.

In another preferred embodiment, the container is made of a water-permeable and water-insoluble polymer selected from butyral resin, polyvinyl acetal, poly(vinyl butyral-co-vinyl alcohol-co-vinyl acetate), polyvinyl butyrate, polyvinyl acetate and combinations and co-monomers thereof.

Most preferably, the container is made of polyvinyl alcohol, a copolymer of polyvinyl alcohol and combinations thereof. Polyvinyl alcohols preferred have a weight average molecular weight between 1,000 and 300,000, more preferably, between 2,000 and 150,000, and most preferably, between 3,000 and 100,000.

In a particularly preferred embodiment of the invention, the detergent product comprises a water-permeable sachet, said sachet comprising at least 50 wt %, preferably at least 75 wt %, more preferably at least 90 wt % of a polymer material chosen from the water-permeable and water-soluble polymers listed above. In an especially preferred embodiment, the polymer material is polyvinyl alcohol (PVA).

According to a preferred embodiment, the sachet comprises 5-40 ml, more preferably 8-30-ml and most preferably 10-20-ml of the detergent formulation.

The benefits of the invention are particularly appreciated in case the water permeability of the container enables the hygroscopic liquid formulation to rapidly attract a significant amount of water when the product is stored under moist conditions. Typically, when a detergent product (container+detergent formulation) according to the present invention is kept at a temperature of 37° C. and a relative humidity (RH) of 70% for 14 days, the detergent formulation shows a weight increase of at least 1%, more preferably of at least 2%, most preferably at least 3% by weight of the detergent formulation. Preferably, the detergent formulation shows a weight increase under these conditions of at most 25%, more preferably at most 20%, most preferably at most 15% by weight of the detergent formulation.

In accordance with another embodiment, the container is made of water-insoluble, water-impermeable material. Examples of suitable containers are bottles, a capsule, a sachet, a pouch, a bag or a bottle, although other container forms are also envisaged. According to a particularly preferred embodiment, the container is a bottle.

The present detergent product offers the advantage that despite the high water content of the detergent formulation bleaching agent is relatively stable within said formulation. Typically, bleach activity of a freshly prepared formulation according to the present invention decreases by not more than 50%, more preferably by not more than 40% and most preferably by not more than 30% when the detergent product (detergent formulation in the container) is stored for 14 days at 37° C. and 70% relative humidity, using the procedure described herein before. Bleach activity may suitably be determined by iodometric titration. In this titration a suitable amount of detergent sample containing a bleaching agent is dissolved in acidified water containing a molybdate catalyst. Subsequently potassium iodide is added to an aliquot of the solution. The iodine liberated by the bleaching agent is titrated with sodium thiosulphate solution.

The invention further relates to a process for preparing a detergent formulation as defined herein, said process comprising:
a. providing a liquid aqueous solution comprising 1-70 wt %, preferably 2-50 wt % of an acid, said aqueous solution containing 0-50 wt % of an aminocarboxylate chelant comprising at least three carboxylate residues;
b. combining said solution with an aminocarboxylate concentrate, wherein said concentrate contains at least 65 wt. % of an aminocarboxylate chelant comprising at least three carboxylate residues.

The liquid aqueous solution typically contains at least 30 wt. %, more preferably least 40 wt. % and most preferably at least 50 wt. % water.

The liquid aqueous solution typically contains 5-48 wt. %, more preferably 10-47 wt. % and most preferably 20-45 wt. % of the aminocarboxylate chelant.

The pH of the liquid aqueous solution typically is less than 10. Preferably, the pH of the liquid aqueous solution is within the range of 3 to 9, most preferably in the range of 5 to 8.

The aminocarboxylate concentrate typically contains 70-90 wt. %, most preferably 75-85 wt. % of aminocarboxylate. The aminocarboxylate concentrate preferably is a powder.

In an advantageous embodiment of the present process, the liquid aqueous solution is prepared by combining a liquid mixture of water and aminocarboxylate chelant with the acid (e.g. an aqueous solution of the acid), followed by addition of the aminocarboxylate concentrate in particulate form.

The moisture-sensitive detergent ingredients are preferably added after the liquid aqueous solution containing the acid has been combined with the aminocarboxylate concentrate.

The invention is further illustrated by means of the following non-limiting examples.

### EXAMPLES

### Example 1

Premixes 1-3 comprising GLDA, citric acid and water were prepared on the basis of the formulations presented in Table 1 (all percentages by weight).

TABLE 1

| | | | | Citric |
|---|---|---|---|---|
| | | GLDA | Water | acid |
| Premix 1 | | | | |
| Dissolvine ™ GL 47-S¹⁾ | 65% | 31% | 29% | |
| (47%) | | | | |
| Citric acid (50%) | | | | |
| Dissolvine ™ PD-S²⁾ | 35% | 28% | 3% | |
| (80%) | | | | |
| Total | 100% | 59% | 32% | |
| Premix 2 | | | | |
| Dissolvine ™ GL 47-S | 49% | 23% | 22% | |
| Citric acid | 10% | | 5% | 5% |
| Dissolvine ™ PD-S | 41% | 33% | 3% | |
| Total | 100% | 56% | 30% | 5% |
| Premix 3 | | | | |
| Dissolvine ™ GL 47-S | 34% | 16% | 15% | |
| Citric acid | 20% | | 10% | 10% |
| Dissolvine ™ PD-S | 46% | 37% | 4% | |
| Total | 100% | 53% | 29% | 10% |

^{1,2)}AkzoNobel, The Netherlands

The liquid premixes were prepared by adding citric acid to Dissolvine™ GL 47-S at ambient temperature. Subsequently Dissolvine™ PD-S was admixed to the Dissolvine™ solution under stirring.

Next, detergent formulations were prepared by adding 10% by weight of the premix formulations of coated sodium percarbonate bleaching agent ex Degussa under stirring.

The water activity (A_{w}) of each of the formulations was measured using a Novasina Labmaster at 25° C. Furthermore, the pH of the formulations was determined. The results are presented in Table 2.

TABLE 2

| Formulation | water activity (A_{w}) | pH |
|---|---|---|
| 1 | 0.41 | 12.5 |
| 2 | 0.47 | 9.7 |
| 3 | 0.45 | 8.8 |

### Percarbonate Degradation Test

The detergent formulations of Example 1 were filled into transparent pouches made of two sheets of polyvinyl alcohol, one sheet having a thickness of 45 μm, the other having a thickness of 60 μm. Each pouch contained about 12 ml of the detergent formulation.

The pouches were stored in a climate chamber at a temperature of 37° C. and at 70% relative humidity. Percarbonate degradation was assessed by determining the washing-active oxygen (available oxygen, ‘AVOX’) of the percarbonate bleaching agent directly after and 14 days after preparation, according to the following protocol:
50 ml of a 3 M aqueous sulphuric acid solution is added to a 1000 ml graduated flask (V1).
Next, 20 g of the sample is weighed into the flask to the nearest 0.001 g (W).
The resulting mixture is diluted to volume and mixed for 45 minutes.
15 ml of a 3 M aqueous sulphuric acid solution is added to a 250 ml stoppered flask.
25 ml of the test solution (V2) is pipetted into this flask, after which some drops of saturated ammonium heptamolybdate solution and 15 ml of 10% w/v potassium iodide solution are added.
The flask is stoppered, mixed by swirling and allowed to stand for at least 5 minutes in the dark.
Then, the mixture is titrated with standardized 0.1000 mol/l sodium thiosulphate solution (c) until the brown colour of the liberated iodine has disappeared (V3).
The weight percentage of available oxygen is calculated according to the following formula:

$$available oxygen = \frac{V 1 * V 3 * c * 16 * 100}{2 * 1000 * W * V 2} * 100 \%$$

The residual washing-active oxygen (Residual AVOX′) was determined according to the following formula:

Residual AVOX=100%×(AVOX on day 14)/(AVOX directly after preparation)

The results are presented in Table 3.

TABLE 3

| | Residual |
|---|---|
| Formulation | AVOX |
| Premix 1 | 76% |
| Premix 2 | 60% |
| Premix 3 | 44% |

These results demonstrate that acidification of the detergent formulation results in a decrease in percarbonate stability. Remarkably, this decrease in percarbonate stability was found not to be accompanied by inflation of the capsule due to gas formation.

### Water Uptake Test

The aforementioned pouches were stored in a climate chamber at 37° C. and 70% RH during 14 days. The pouches were weighed at regular intervals. The water uptake was calculated using the following formula:

water uptake=(weight on day x−weight on day 0)/(weight on day 0)

The results are presented in Table 4.

TABLE 4

| | day | day | day | day | day | day | day | day | day | day |
|---|---|---|---|---|---|---|---|---|---|---|
| Formulation | 1 | 2 | 5 | 6 | 7 | 8 | 9 | 12 | 13 | 14 |
| 1 | 3.10 | 5.06 | 10.52 | 11.80 | 12.78 | 14.11 | 15.40 | 19.39 | 19.42 | 19.81 |
| 2 | 2.27 | 3.75 | 6.60 | 7.47 | 8.31 | 9.43 | 10.10 | 12.26 | 12.80 | 13.11 |
| 3 | 1.63 | 2.49 | 5.02 | 5.70 | 6.48 | 7.14 | 7.69 | 9.48 | 10.02 | 10.37 |

From day 5 onwards, the pouches containing formulation 1 displayed spontaneous bursting.

On day 8, the pouches containing formulation 2 started to expand and from day 12 onwards spontaneous bursting was observed.

The pouches containing formulation 3 displayed neither expansion nor bursting.

### Example 2

Premixes 1-3 comprising GLDA, acid and water as well as a control were prepared on the basis of the formulations presented in Table 5 (all percentages by weight).

TABLE 5

| | | | | Citric | Sulphuric |
|---|---|---|---|---|---|
| | | GLDA | Water | acid | acid |
| Premix 1 | | | | | |
| Dissolvine ™ GL 47-S¹⁾ | 49% | 23% | 22% | | |
| (47%) | | | | | |
| Citric acid (50%) | 10% | | 5% | 5% | |
| Dissolvine ™ PD-S²⁾ | 41% | 33% | 3% | | |
| (80%) | | | | | |
| Total | 100% | 56% | 30% | 5% | |
| Premix 2 | | | | | |
| Dissolvine ™ GL 47-S | 34% | 16% | 15% | | |
| Citric acid | 20% | | 10% | 10% | |
| Dissolvine ™ PD-S | 46% | 37% | 4% | | |
| Total | 100% | 53% | 29% | 10% | |
| Premix 3 | | | | | |
| Dissolvine ™ GL 47-S | 49% | 23% | 22% | | |
| Sulphuric acid (50%) | 10% | | 5% | | 5% |
| Dissolvine ™ PD-S | 41% | 33% | 3% | | |
| Total | 100% | 56% | 30% | | 5% |
| Control | | | | | |
| Dissolvine ™ GL 47-S | 65% | 31% | 29% | | |
| Dissolvine ™ PD-S | 35% | 28% | 3% | | |
| Total | 100% | 59% | 32% | | |

^{1,2)}AkzoNobel, The Netherlands

The liquid premixes were prepared by adding the acid component to Dissolvine™ GL 47-S at ambient temperature. Subsequently Dissolvine™ PD-S was admixed to the Dissolvine™ solution under stirring.

The pH of the premixes and the control was measured. The results are shown in Table 6.

TABLE 6

| Formulation | pH |
|---|---|
| Control | 12.5 |
| Premix 1 | 9.7 |
| Premix 2 | 8.8 |
| Premix 3 | 9.7 |

The hygroscopicity of the premixes was determined by:
introducing samples of 25 g in a plastic (PE) petri dish (inner diameter=105 mm)
keeping the samples in a storage chamber at a temperature of 20° C. and a relative humidity (RH) of 64% for 7 days
weighing the petri dishes together with their contents at regular intervals
calculating the change in weight as a percentage of the weight of the original sample (25 g)

The results of this test are shown in Table 7.

TABLE 7

| | Days storage | | | | |
|---|---|---|---|---|---|
| | 1 | 4 | 5 | 6 | 7 |
| Control | 14% | 33% | 36% | 38% | 39% |
| Premix 1 | 9% | 24% | 28% | 30% | 31% |
| Premix 2 | 7% | 18% | 21% | 22% | 24% |
| Premix 3 | 11% | 25% | 26% | 27% | 27% |

### Comparative Example A

A premix comprising GLDA, citric acid and water was prepared on the basis of the formulation presented in Table 8 (all percentages by weight).

TABLE 8

| | | | | Citric |
|---|---|---|---|---|
| Premix 1 | | GLDA | Water | acid |
| Dissolvine ™ GL 47-S¹⁾ | 83% | 39% | 37% | |
| (47%) | | | | |
| Citric acid (50%) | 4% | | 2% | 2% |
| Water | 13% | | 13% | |
| Total | 100% | 39% | 52% | 2% |

Next, 10% by weight of the premix formulation of coated sodium percarbonate bleaching agent ex Degussa was added under stirring. The product so obtained had a pH of 9.0 and a water activity of 0.74.

The product was filled into transparent PVA pouches as described in Example 1. Three pouches were stored in a climate chamber at 37° C./70% RH during 7 days. As a reference a pouch containing the premix without added bleaching agent was subjected to the same test. The results of this test are depicted in Table 9.

TABLE 9

| | | Days storage | | | | | |
|---|---|---|---|---|---|---|---|
| | t = 0 | 1 | 2 | 3 | 4 | 5 | 7 |
| No bleach | No | No | No | No | No | No | No |
| | inflation | inflation | inflation | inflation | inflation | inflation | inflation |
| With bleach | No | Inflated | Inflated | Burst | Burst | Burst | Burst |
| | inflation | | | | | | |

After 7 days storage the residual washing-active oxygen (AVOX′) amounted to only 10%.

1. A detergent formulation comprising water, one or more moisture-sensitive detergent ingredients and an aminocarboxylate chelant comprising at least three carboxylate residues;
wherein the combination of aminocarboxylate chelant and water represents at least 20% by weight of the detergent formulation;
wherein the weight ratio of aminocarboxylate chelant to water lies within the range of 5:6 to 5:1;
wherein the detergent formulation has a pH in the range of 7.2 to 12; and
wherein the detergent formulation when containing citric acid and GLDA, contains citric acid and GLDA in a molar ratio of more than 1:10; and
wherein the detergent formulation when containing citric acid and MGDA, contains citric acid and MGDA in a molar ratio of more than 1:18.

2. Detergent formulation according to claim 1, wherein the detergent formulation when kept at a temperature of 20° C. and a relative humidity of 64% for 7 days shows a weight increase of at least 1% by weight of the detergent formulation.

3. Detergent formulation according to claim 1, wherein the weight ratio of aminocarboxylate chelant to water lies within the range of 9:10 to 3:1, preferably of 1:1 to 5:2.

4. Detergent formulation according to claim 1, wherein the aminocarboxylate chelant and water together represent at least 60% by weight of the detergent formulation, preferably at least 65% by weight of the detergent formulation.

5. Detergent formulation according to claim 1, wherein the detergent formulation contains 25-80 wt. %, preferably 30-75 wt. % of the aminocarboxylate chelant.

6. Detergent formulation according to claim 1, wherein the detergent formulation contains 10-55 wt. %, preferably 15-50 wt. % water.

7. Detergent formulation according to claim 1, wherein the aminocarboxylate chelant is GLDA.

8. Detergent formulation according to claim 1, wherein the detergent formulation contains 5-100 mmoles, preferably 10-80 mmoles of the conjugate base of one or more acids per 100 g of detergent formulation, said one or more acids being selected from citric acid, hydroxyacetic acid, formic acid, acetic acid, propionic acid, butyric acid, valeric acid, caproic acid, gluconic acid, itaconic acid, trichloroacetic acid, urea hydrochloride, benzoic acid, oxalic acid, malic acid, malonic acid, succinic acid, glutaric acid, maleic acid, fumaric acid, adipic acid, terephthalic acid, sulphuric acid, sulfamic acid, methylsulfamic acid, hydrochloric acid, hydrobromic acid, hydrofluoric acid, and nitric acid.

9. Detergent formulation according to claim 1, wherein the detergent formulation has a pH in the range of 7.5-11.5, preferably in the range of 7.8-11.0.

10. Detergent formulation according to claim 1, wherein the detergent formulation has a water activity of not more than 0.85, preferably of not more than 0.75.

11. Detergent formulation according to claim 1, wherein the moisture-sensitive detergent ingredient is selected from moisture sensitive bleaching agents, moisture sensitive bleach activators, moisture sensitive bleach catalysts, moisture sensitive perfumes, moisture sensitive colorants, moisture sensitive enzymes and combinations thereof.

12. Detergent product comprising
a. a container, and
b. a detergent formulation that is contained in said container, wherein the detergent formulation is a detergent formulation according to claim 1.

13. Detergent product according to claim 12, wherein the container is a water-permeable sachet.

14. A process for preparing a detergent formulation according to claim 1, comprising
a. providing a liquid aqueous solution comprising 1-70 wt %, preferably 2-50 wt % of an acid, said aqueous solution containing 0-50 wt % of an aminocarboxylate chelant comprising at least three carboxylate residues
b. combining said solution with an aminocarboxylate concentrate, wherein said concentrate contains at least 65 wt. % of an aminocarboxylate chelant comprising at least three carboxylate residues.

15. Process according to claim 14, wherein the liquid aqueous solution contains at least 30 wt. % water and 5-48 wt. % of the aminocarboxylate chelant.
